(19) United States
(12) Patent Application Publication
(10) Pub. No.: US 2022/0383641 A1
(43) Pub. Date: Dec. 1, 2022

(54) SAFETY SYSTEM FOR A MOBILE VEHICLE AND CONTROL METHOD THEREOF

(71) Applicants: ELAN MICROELECTRONICS CORPORATION, Hsin- Chu (TW); AVISONIC TECHNOLOGY CORPORATION, Hsin Chu (TW)

(72) Inventors: I-Hau YEH, Hsinchu City (TW); Kuo-Ching HUNG, Zhudong Township (TW); Meng-Chun LIN, Taipei City (TW)

(21) Appl. No.: 17/746,266

(22) Filed: May 17, 2022

Related U.S. Application Data
(60) Provisional application No. 63/194,190, filed on May 28, 2021.

(30) Foreign Application Priority Data
Mar. 17, 2022 (TW) 111109793

(51) Int. Cl. G06V 20/58; G06T 7/70; B60R 1/22; B60W 50/14

(52) U.S. Cl. CPC G06V 20/58; G06T 7/70; B60R 1/22; B60W 50/14; B60W 2050/143; B60R 2300/30; B60R 2300/802; G06T 2207/20084; G06T 2207/30252

(57) ABSTRACT

A safety system for a vehicle includes a camera and a central control device. The camera is configured to obtain a first image. When the central control device determines that the vehicle is in a straight-moving state, the central control device determines whether a target object is in a first range on a side of the vehicle according to the first image. When the central control device determines that the vehicle is in a turning state, the central control device determines whether the target object is in a second range on the side of the vehicle according to the first image, wherein the second range is larger than the first range.

This application claims priority of Application No. 111109793 filed in Taiwan on 17 Mar. 2022 under 35 U.S.C. § 119; and this application claims priority of U.S. Provisional Application No. 63/194,190 filed on 28 May 2021 under 35 U.S.C. § 119(e); the entire contents of all of which are hereby incorporated by reference.

### BACKGROUND OF THE INVENTION

### Field of the Invention

The present invention relates to a safety system for a vehicle, particularly to a safety system for dynamically adjusting monitor ranges and a control method thereof.

### Description of the Related Art

When a driver is driving a vehicle, a blind zone may be created due to the structure of the vehicle body. For example, vehicles or people on the side of the vehicle or behind the vehicle cannot be seen. To improve safety, drivers need safety systems to monitor blind zones.

### SUMMARY OF THE INVENTION

One objective of the present invention is to provide a safety system for dynamically adjusting monitor ranges and a control method thereof.

According to the present invention, the safety system for a vehicle includes a camera, a host, and a central control device. The camera is configured to obtain a first image. The host is configured to output vehicle information. The central control device is configured to receive the first image and the vehicle information. When the central control device determines that the vehicle is in a straight-moving state according to the vehicle information, the central control device determines whether there is a target object within a first range on a side of the vehicle according to the first image. When the central control device determines that the vehicle is in a turning state according to the vehicle information, the central control device determines whether there is the target object within a second range on the side of the vehicle according to the first image. The second range is larger than the first range. The central control device identifies the target object with artificial intelligence (AI).

According to the present invention, a control method of a safety system for a vehicle includes a. obtaining a first image; b. when the vehicle is in a straight-moving state, determining whether there is a target object within a first range on a side of the vehicle according to the first image; c. when the vehicle is in a turning state, determining whether there is the target object within a second range on the side of the vehicle according to the first image; wherein the second range is larger than the first range; wherein in steps b and c, the target object is identified with artificial intelligence (AI).

The safety system of the present invention can dynamically adjust the monitor ranges. When the vehicle is in a straight-moving state, the safety system monitors the smaller first range (e.g., a first area), thereby achieving faster and more immediate monitoring. When the vehicle is in a turning state, the safety system monitors the larger second range, which is helpful in improving driving safety.

Below, the embodiments are described in detail in cooperation with the drawings to make easily understood the technical contents, characteristics and accomplishments of the present invention.

### BRIEF DESCRIPTION OF THE DRAWINGS

FIG. 1 shows a vehicle using a safety system of the present invention;

FIG. 2 shows monitor ranges of the safety system in FIG. 1;

FIG. 3 shows an embodiment of an image processing unit in FIG. 1;

FIG. 4 shows a first embodiment of a control method of a safety system of the present invention;

FIG. 5 shows an embodiment of obtaining the coordinates of a target object; and

FIG. 6 shows a second embodiment of a control method of a safety system of the present invention.

### DETAILED DESCRIPTION OF THE INVENTION

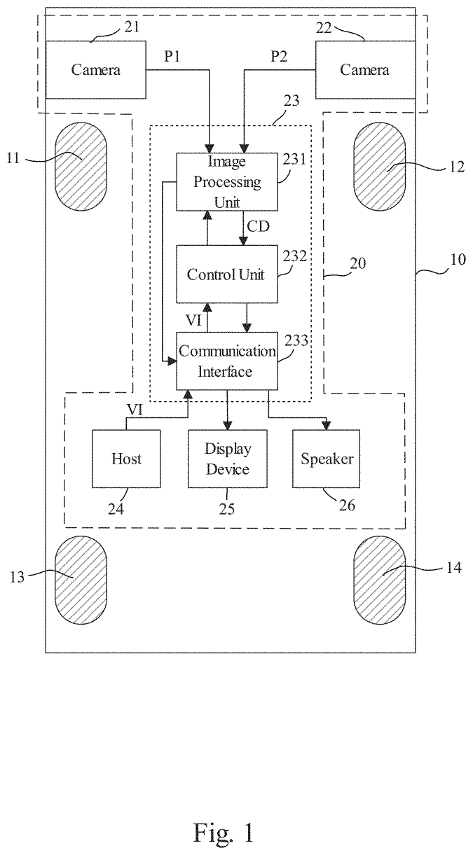

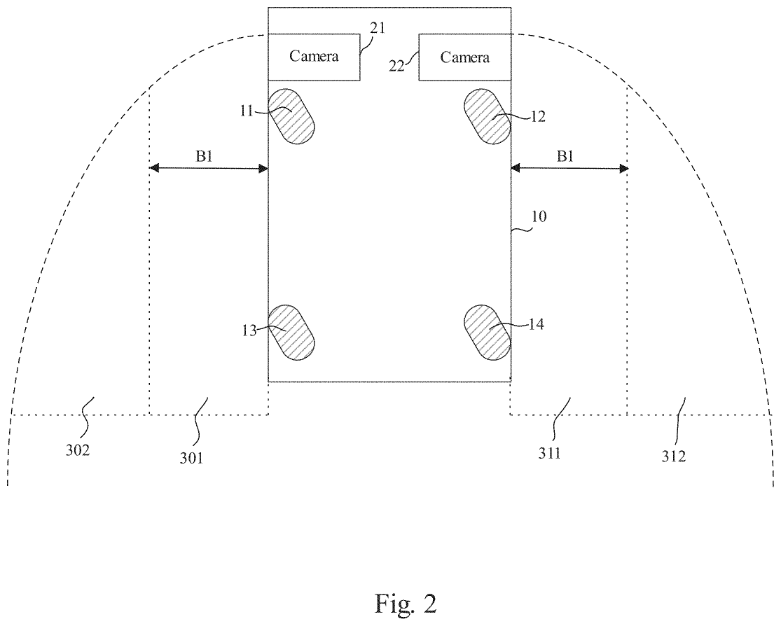

FIG. 1 shows a vehicle using a safety system of the present invention. FIG. 2 shows monitor ranges of the safety system in FIG. 1. A vehicle 10 in FIG. 1 may be, but not limited to, a bus, a truck, a large lorry, a trailer, or a sedan. The vehicle 10 has a plurality of wheels 11, 12, 13, and 14 that are configured to move the vehicle 10. The vehicle 10 is equipped with a safety system 20. The safety system 20 is configured to monitor whether there is a target object on a side of the vehicle 10. The target object may be, but not limited to, people or other vehicles. The safety system 20 includes cameras 21 and 22, a central control device 23, a host 24, a display device 25, and a speaker 26. The camera 21 is arranged on the left side of the vehicle 10 and configured to obtain a first image P1 which shows the left side of the vehicle 10. The camera 22 is arranged on the right side of the vehicle 10 and configured to obtain a first image P2 which shows the right side of the vehicle 10. The first image P1 shows a first area 301 and a second area 302. The first image P2 shows a first area 311 and a second area 312. The first area 301 is between the vehicle 10 and the second area 302. The first area 311 is between the vehicle 10 and the second area 312. Assume that the vehicle 10 is a bus. The camera 21 can be installed on, but not limited to, the housing of the left-side rearview mirror, the left-side vehicle body, or the left side of the vehicle roof. The camera 22 can be installed on, but not limited to, the housing of the right-side rearview mirror, the right-side vehicle body, or the right side of the vehicle roof. In an embodiment, the cameras 21 and 22 may be, but not limited to, general or wide-angle cameras. When the cameras 21 and 22 are 180-degree wide-angle cameras, the camera 21 can monitor areas on the left side, the left rear side and the left front side, and the camera 22 can monitor areas on the right side, the right rear side and the right front side. In one embodiment, the width B1 of each of the first areas 301 and 311 may be, but not limited to, the width of a vehicle, the width of a lane, or 3.5 m.

The host 24 in FIG. 1 is configured to provide vehicle information VI. In an embodiment, the host 24 may be an electronic control unit (ECU) that mainly controls the vehicle 10. The vehicle information VI includes, but not limited to, at least one of moving speed, rotation angle of a steering wheel, rotation direction of a steering wheel, a turning signal, an accelerator signal, and a braking signal.

The central control device 23 is coupled to the cameras 21 and 22 and the host 24. The central control device 23 obtains the vehicle information VI form the host 24 and determines that the vehicle 10 is in a straight-moving state or a turning state according to the vehicle information VI. For brevity, monitoring only the environment on the left side of the vehicle 10 will be described as follows since the method for monitoring the left side and the right side are the same. When the central control device 23 determines that the vehicle 10 is in the straight-moving state according to the vehicle information VI, the central control device 23 determines whether there is a target object within a first range according to the first image P1 obtained by the camera 21. The first range is corresponding to the first area 301. When the central control device 23 determines that the vehicle 10 is in the turning state according to the vehicle information VI, the central control device 23 determines whether there is the target object within a second range according to the first image P1. The second range is larger than the first range. The second range is corresponding to an area comprised the first area 301 and the second area 302. In an embodiment, the central control device 23 identifies the target object with artificial intelligence (AI). In an embodiment, an artificial intelligence (AI) model used to identify the target object may be, but not limited to, MobileNet-SSD.

In the embodiment of FIG. 1, the central control device 23 includes an image processing unit 231, a control unit 232, and a communication interface 233. The image processing unit 231 is coupled to the cameras 21 and 22 and configured to receive the plurality of first images P1 and P2 provided by the cameras 21 and 22. The image processing unit 231 identifies the target objects in the first images P1 and P2 with AI to generate object information CD. The object information CD represents results of identifying the target objects. In an embodiment, the object information CD includes object types and coordinate information. The coordinate information represents the ranges or positions of the identified target objects in the first images P1 and P2.

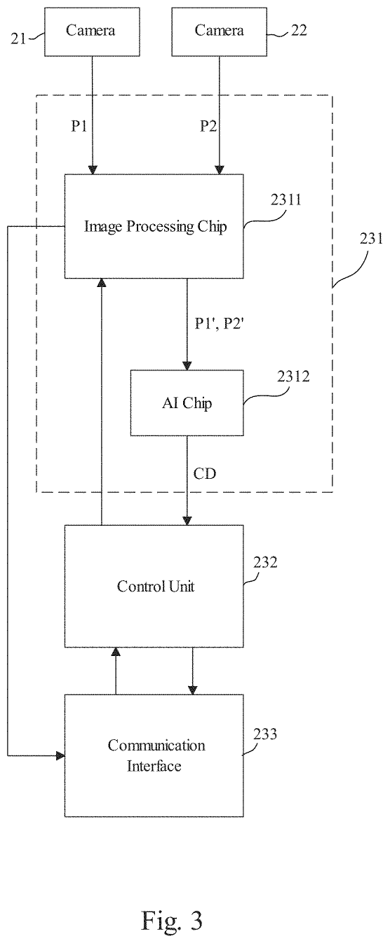

For example, as shown in FIG. 3, the image processing unit 231 includes an image processing chip 2311 and an artificial intelligence (AI) chip 2312. The AI chip 2312 is coupled to the image processing chip 2311 and the control unit 232. The image processing chip 2311 is coupled to the cameras 21 and 22 and the control unit 232. The image processing chip 2311 receives the first images P1 and P2 and performs image processing on the first images P1 and P2 respectively to generate second images P1′ and P2′. The image processing may include, for example, elimination of noise, scaled-down size, correction of distortion, or acquiring a part of the first image P1 and a part of the first image P2. The AI chip 2312 performs object identification on the second images P1′ and P2′ with AI to generate the object information CD. The AI chip 2312 may implement the AI with, but not limited to, a Convolutional Neural Network (CNN).

The communication interface 233 is coupled to the host 24, the display device 25, and the speaker 26. The communication interface 233 is configured to receive the vehicle information VI from the host 24 and transmit data to the display device 25 and the speaker 26. The control unit 232 is coupled to the image processing unit 231 and the communication interface 233. The control unit 232 receives the object information CD and the vehicle information VI from the communication interface 233 to control the operation of the image processing unit 231. In the embodiment of FIG. 1, the communication interface 233 is further coupled to the image processing unit 231. The image processing unit outputs and transmits images to the display device 25 through the communication interface 233.

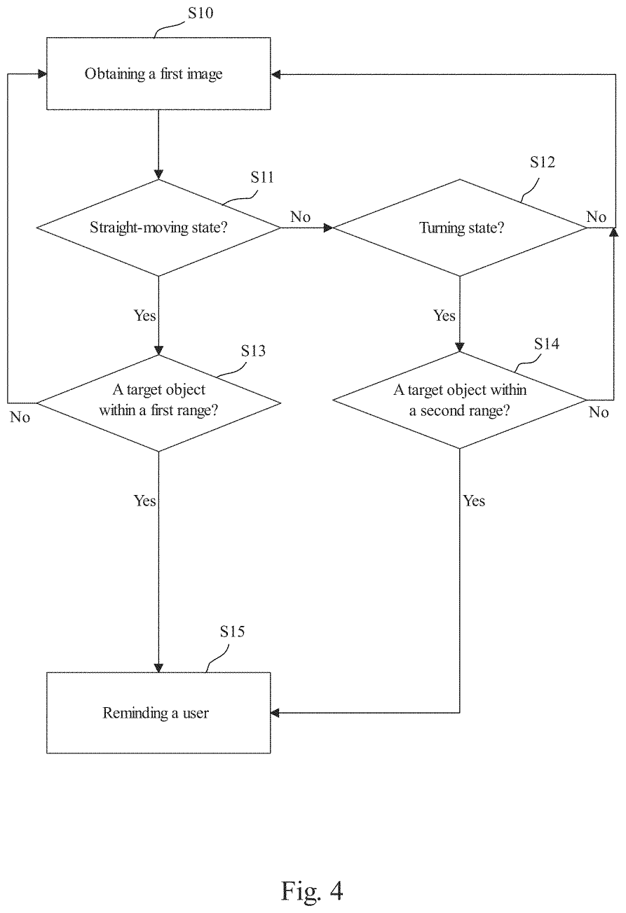

FIG. 4 shows a first embodiment of a control method of a safety system of the present invention. For brevity, monitoring only the environment on the left side of the vehicle 10 will be described as follows. Please refer to FIGS. 1-4. In Step S10, the image processing unit 231 receives the first image P1 obtained by the camera 21. The first image P1 shows the first area 301 and the second area 311. The photographing action of the camera 21 is continuously performed. Thus, a plurality of first images P1 are continuously outputted to the image processing unit 231. In Step S11, the central control device 23 determines whether the vehicle 10 is in the straight-moving state according to the vehicle information VI. When the central control device 23 determines that the vehicle 10 is in the straight-moving state, the safety system 20 performs Step S13. When the central control device 23 determines that the vehicle 10 is not in the straight-moving state, the safety system 20 performs Step S12. In Step S12, the central control device 23 determines whether the vehicle 10 is in the turning state according to the vehicle information VI. When the central control device 23 determines that the vehicle 10 is in the turning state, the safety system 20 performs Step S14. When the central control device 23 determines that the vehicle 10 is not in the turning state, the safety system 20 returns to Step S10.

In Step S13, the central control device 23 determines whether there is the target object within the first range (e.g., the first area 301) according to the first image P1. In an embodiment, the central control device 23 performs object identification with AI on the first image P1. When the target object is identified, the central control device 23 obtains the coordinate of the target object. When the central control device 23 determines that the coordinate of the target object are within a first preset area of the first image P1, the central control device 23 determines that there is the target object within the first range. The first preset area of the first image P1 corresponds to the first range. When the central control device 23 determines that there is no target object within the first range, the safety system 20 returns to Step S10. When the central control device 23 determines that there is the target object within the first range, the safety system 20 performs Step S15 to remind a user.

In Step S14, the central control device 23 determines whether there is the target object within the second range (e.g., including the first area 301 and the second area 302). For example, the central control device 23 performs object identification with AI on the first image P1. When the target object is identified, the central control device 23 obtains the coordinate of the target object. When the central control device 23 determines that the coordinates of the target object are within a second preset area of the first image P1, the central control device 23 determines that there is the target object within the second range. The second preset area of the first image P1 corresponds to the second range. When the central control device 23 determines that there is no target object within the second range, the safety system 20 returns to Step S10. When the central control device 23 determines that there is the target object within the second range, the safety system 20 performs Step S15 to remind a user.

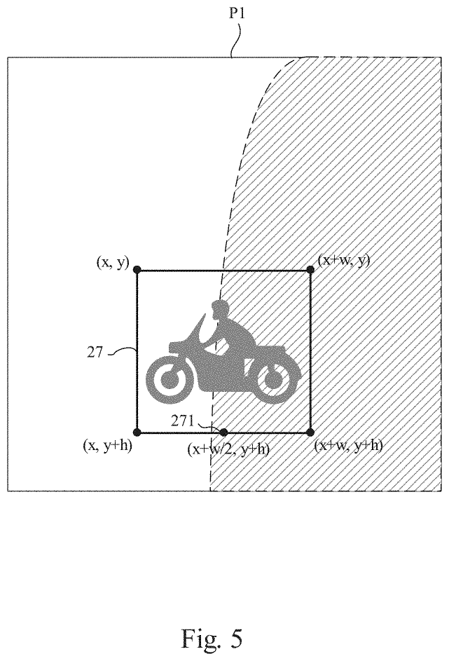

FIG. 5 shows an embodiment of calculating the coordinate of a target object in Steps S13 and S14. FIG. 5 shows the first image P1 obtained by the camera 21. The central control device 23 determines a bounding box (BB) 27 of the target object in the first image P1 and calculates the coordinate of the target object according to the bounding box 27. For example, the central control device 23 may use, but not limited to, the coordinate (x+w/2, y+h) of a central point 271 of the bottom of the bounding box 27 as the coordinate of the target object. When the central control device 23 determines that the coordinate (x+w/2, y+h) of the target object is within the first preset area (e.g., a slashed area in FIG. 5) of the first image P1, the central control device 23 determines that there is the target object within the first range.

In an embodiment of Step S15, the central control device 23 generates and transmits a warning signal to the speaker 26 through the communication interface 233. The warning signal is an audio signal. The speaker 26 play warning sounds in response to the first warning signal, so as to remind the user.

In another embodiment of Step S15, the central control device 23 performs post processing on the first image P1 to generate a post-processed image and transmits the post-processed image to the display device 25. The display device 25 displays the post-processed image to remind the user. Specifically, when the target object is identified within the first range or the second range, the control unit 232 controls the image processing unit 2311 to perform post processing on the first image P1. The image processing unit 2311 transmits the post-processed image to the display device 25 through the communication interface 233. The post processing includes, but not limited to, correction of distortion, marking or superimposing texts on images, marking or superimposing pictures on images, brightness adjustment, color changes, image distortion, enlargement or reduction of image, enlargement or reduction of a portion of the image, image rotation, image segmentation, and image stitching. The display device 25 may be, but not limited to, an electronic rearview mirror.

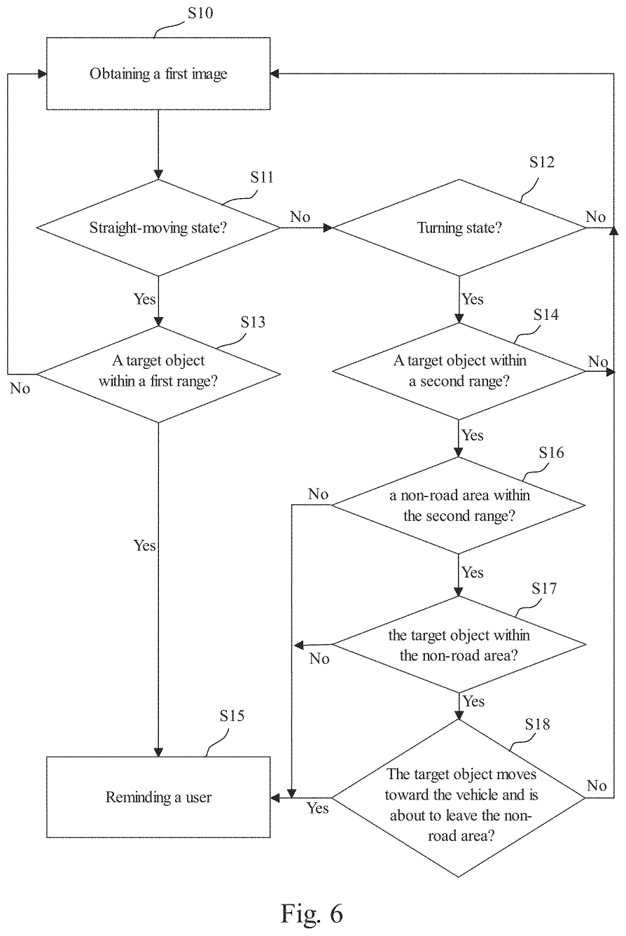

FIG. 6 shows a second embodiment of a control method of a safety system of the present invention. For brevity, monitoring only the environment on the left side of the vehicle 10 will be described as follows. Steps S10, S11, S12, S13, and S15 of FIG. 6 are the same to those of FIG. 4. In Step S14 of FIG. 6, when the control unit 232 of the central control device 23 determines that there is the target object within the second range, Step S16 is performed. In Step S14, when the control unit 232 determines that there is no target object within the first area 301, the safety system 20 returns to Step S10. In Step S16, the control unit 232 determines whether there is a non-road area within the second range. If there is no non-road area within the second range, Step S15 is performed. If there is the non-road area within the second range, Step S17 is performed. The non-road area is an area other than roads. The non-road area includes, but not limited to, sidewalks. In an embodiment, the control unit 232 may control the AI chip 2312 to identify the non-road area with AI.

In Step S17, the control unit 232 of the central control device 23 determines whether there is the target object within the non-road area. Specifically, when the control unit 232 determines that the coordinate of the target object obtained in Step S14 is within the area of the first image P1 corresponding to the non-road area, the control unit 232 determines that there is the target object within the non-road area and performs Step S18. If the control unit 232 determines that there is no target object within the non-road area, Step S15 is performed.

In Step S18, the control unit 232 determines the moving direction of the target object according to subsequent plurality of first images P1 generated by the camera. For example, according to subsequent plurality of object information CD (coordinates) of the target object in the subsequent plurality of first images P1, the control unit 232 can determine the moving direction of the target object and determine whether the moving direction is toward the vehicle 10. When the control unit 232 determines that the target object within the second area 302 does not move toward the vehicle 10, the safety system 20 returns to Step S10. When the control unit 232 determines that the moving direction of the target object is toward the vehicle 10, the control unit 232 determines whether the target object is about to leave the non-road area. If the result is yes, Step S15 is performed. If the result is no, the safety system 20 returns to Step S10. In an embodiment, when a distance between the target object and the boundary of the non-road area near the vehicle 10 is less than or equal to a preset value, the control unit 232 determines that the target object is about to leave the non-road area. In an embodiment, the way of reminding the user in Step S15 may also vary according to Step S13, Step S14, or Step S18.

In an embodiment, the target object comprises more vulnerable individuals such as people and two-wheeled vehicle (such as bicycle and motorcycle). Collision between such individual and vehicle 10 are likely to endanger life safety. For drivers of large vehicles (such as buses or trucks), since only vulnerable individuals are monitored, the number of warnings can be reduced to avoid the distraction of the driver. Besides, the driver can be less tired of too many warnings.

In other embodiments, it is also possible to change the order of some of the steps in FIG. 4 and FIG. 6. According to the foregoing description, the control method of the present invention should be understood to include steps:
a. obtaining a first image;
b. when the vehicle is in a straight-moving state, determining whether there is a target object within a first range on a side of the vehicle according to the first image; and
c. when the vehicle is in a turning state, determining whether there is the target object within a second range on the side of the vehicle according to the first image.
   The second range is larger than the first range. In the steps b and c, the target object is identified with artificial intelligence (AI).

According to the embodiments provided above, when the vehicle 10 is in a straight-moving state, the safety system 20 monitors the smaller first range to achieve the faster and more immediate monitoring. When the vehicle 10 is in a turning state, the safety system 20 monitors the larger second range. In other words, the present invention automatically expands the monitor range when the vehicle 10 turns, which helps improve safety, especially for large vehicles, such as buses and trucks.

The embodiments described above are only to exemplify the present invention but not to limit the scope of the present invention. Therefore, any equivalent modification or variation according to the shapes, structures, features, or spirit disclosed by the present invention is to be also included within the scope of the present invention.

What is claimed is:

1. A safety system for a vehicle, comprising:
a camera configured to obtain a first image;
a host configured to output vehicle information; and
a central control device coupled to the camera and the host and configured to receive the first image and the vehicle information;
wherein when the central control device determines that the vehicle is in a straight-moving state according to the vehicle information, the central control device determines whether there is a target object within a first range on a side of the vehicle according to the first image;
wherein when the central control device determines that the vehicle is in a turning state according to the vehicle information, the central control device determines whether there is the target object within a second range on the side of the vehicle according to the first image, and the second range is larger than the first range;
wherein the central control device identifies the target object with artificial intelligence.

2. The safety system for the vehicle according to claim 1, wherein when the central control device determines that there is the target object within the first range or the second range, the central control device generates a warning signal.

3. The safety system for the vehicle according to claim 1, wherein when the central control device determines that there is the target object within the second range and a non-road area, the central control device determines a moving direction of the target object according to subsequent plurality of images generated by the camera, and when the target object moves towards the vehicle and a distance between the target object and a boundary of the non-road area near the vehicle is less than or equal to a preset value, the central control device generates a warning signal.

4. The safety system for the vehicle according to claim 1, wherein when the central control device determines that the vehicle is in the straight-moving state, the central control device performs object identification with the artificial intelligence on the first image to obtain a coordinate of the target object, and when the central control device determines that the coordinate is within a first preset area of the first image, the central control device determines that there is the target object within the first range.

5. The safety system for the vehicle according to claim 4, wherein the central control device determines the coordinate of the target object according to a bounding box of the target object.

6. The safety system for the vehicle according to claim 4, wherein when the central control device determines that the vehicle is in the turning state, the central control device performs object identification with the artificial intelligence on the first image to obtain the coordinate of the target object, and when the central control device determines that the coordinate is within a second preset area of the first image, the central control device determines that there is the target object within the second range.

7. The safety system for the vehicle according to claim 6, wherein the central control device determines the coordinate of the target object according to a bounding box of the target object.

8. The safety system for the vehicle according to claim 7, wherein the central control device takes a coordinate of a central point of a bottom of the bounding box as the coordinate of the target object.

9. The safety system for the vehicle according to claim 1, wherein the central control device comprises:
an image processing unit coupled to the camera and configured to identify the target object in the first image with the artificial intelligence to generate object information;
a communication interface coupled to the host; and
a control unit coupled to the image processing unit and the communication interface and configured to receive the object information and receive the vehicle information transmitted by the host through the communication interface;
wherein when the control unit determines that the vehicle is in the straight-moving state according to the vehicle information, the control unit determines whether there is the target object within the first range according to the object information;
wherein when the control unit determines that the vehicle is in the turning state according to the vehicle information, the control unit determines whether there is the target object within the second range according to the object information.

10. The safety system for the vehicle according to claim 9, wherein when the control unit determines that there is the target object within the first range or the second range, the control unit generates a warning signal.

11. The safety system for the vehicle according to claim 10, further comprising a speaker coupled to the central control device and configured to play warning sounds in response to the warning signal.

12. The safety system for the vehicle according to claim 9, wherein when the control unit determines that there is the target object within the second range and a non-road area, the control unit determines a moving direction of the target object according to subsequent plurality of object information generated by the image processing unit, and when the target object moves towards the vehicle and a distance between the target object and a boundary of the non-road area near the vehicle is less than or equal to a preset value, the control unit generates a warning signal.

13. The safety system for the vehicle according to claim 12, further comprising a speaker coupled to the central control device and configured to play warning sounds in response to the warning signal.

14. The safety system for the vehicle according to claim 9, wherein the image processing unit comprises:
an image processing chip configured to receive the first image and perform image processing on the first image to generate a second image; and
an artificial intelligence chip coupled to the image processing chip and the control unit and configured to perform object identification with the artificial intelligence on the second image to generate the object information.

15. The safety system for the vehicle according to claim 14, wherein the artificial intelligence chip comprises a convolutional neural network configured to implement the artificial intelligence.

16. The safety system for the vehicle according to claim 9, wherein the control unit controls the image processing unit to perform post processing on the first image based on the object information, and the post processing comprises correction of distortion, marking or superimposing texts or pictures, brightness adjustment, color changes, distortion of images, enlargement of images, reduction of images, rotation of images, segmentation of images, or image stitching.

17. The safety system for the vehicle according to claim 16, further comprising a display device coupled to the central control device through the communication interface and configured to display a post-processed image which is processed by the post processing.

18. The safety system for the vehicle according to claim 17, wherein the display device comprises an electronic rearview mirror.

19. The safety system for the vehicle according to claim 1, wherein the vehicle information comprises at least one of moving speed, rotation angle of a steering wheel, rotation direction of a steering wheel, a turning signal, an accelerator signal, and a braking signal.

20. The safety system for the vehicle according to claim 1, wherein the target object comprises at least one of a person, a bicycle and a motorcycle.

21. A control method of a safety system for a vehicle, comprising the steps of:
a. obtaining a first image;
b. when the vehicle is in a straight-moving state, determining whether there is a target object within a first range on a side of the vehicle according to the first image; and
c. when the vehicle is in a turning state, determining whether there is the target object within a second range on the side of the vehicle according to the first image;
wherein the second range is larger than the first range;
wherein in the steps b and c, the target object is identified with artificial intelligence.

22. The control method of the safety system for the vehicle according to claim 21, further comprising generating a warning signal when there is the target object within the first range or the second range.

23. The control method of the safety system for the vehicle according to claim 22, further comprising playing warning sounds in response to the warning signal.

24. The control method of the safety system for the vehicle according to claim 21, further comprising:
when there is the target object within the second range and a non-road area, determining a moving direction of the target object according to subsequent plurality of images generated by the camera; and
when the moving direction is toward the vehicle and a distance between the target object and a boundary of the non-road area near the vehicle is less than or equal to a preset value, generating a warning signal.

25. The control method of the safety system for the vehicle according to claim 24, further comprising playing warning sounds in response to the warning signal.

26. The control method of the safety system for the vehicle according to claim 21, wherein the step b comprises:
performing object identification with the artificial intelligence on the first image to obtain a coordinate of the target object; and
when the coordinate is within a preset area of the first image, determining that there is the target object within the first range.

27. The control method of the safety system for the vehicle according to claim 26, wherein the step of obtaining the coordinate of the target object comprises determining the coordinate of the target object according to a bounding box of the target object.

28. The control method of the safety system for the vehicle according to claim 21, wherein the step c comprises:
performing object identification with the artificial intelligence on the first image to obtain a coordinate of the target object; and
when the coordinate is within a preset area of the first image, determining that there is the target object within the second range.

29. The control method of the safety system for the vehicle according to claim 28, wherein the step of obtaining the coordinate of the target object comprises determining the coordinate of the target object according to a bounding box of the target object.

30. The control method of the safety system for the vehicle according to claim 29, further comprising taking a coordinate of a central point of a bottom of the bounding box as the coordinate of the target object.

31. The control method of the safety system for the vehicle according to claim 21, further comprising:
identifying the target object in the first image with the artificial intelligence to generate object information;
when the vehicle is in the straight-moving state, determining whether there is the target object within the first range according to the object information; and
when the vehicle is in the turning state, determining whether there is the target object within the second range according to the object information.

32. The control method of the safety system for the vehicle according to claim 31, wherein the step of generating the object information comprises:
performing image processing on the first image to generate a second image; and
performing object identification with the artificial intelligence on the second image to generate the object information.

33. The control method of the safety system for the vehicle according to claim 21, further comprising determining that the vehicle is in the straight-moving state or the turning state according to vehicle information, wherein the vehicle information comprises at least one of moving speed, rotation angle of a steering wheel, rotation direction of a steering wheel, a turning signal, an accelerator signal, and a braking signal.

34. The control method of the safety system for the vehicle according to claim 21, further comprising performing post processing on the first image based on results of identifying the target object, wherein the post processing comprises correction of distortion, marking or superimposing texts or pictures, brightness adjustment, color changes, distortion of images, enlargement of images, reduction of images, rotation of images, segmentation of images, or image stitching.

35. The control method of the safety system for the vehicle according to claim 34, further comprising displaying a post-processed image which is processed by the post processing.

36. The control method of the safety system for the vehicle according to claim 21, wherein the target object comprises at least one of a person, a bicycle and a motorcycle.
